(19) United States
(12) Patent Application Publication
(10) Pub. No.: US 2018/0291576 A1
(43) Pub. Date: Oct. 11, 2018

(54) PLASTIC GUARDRAIL

(71) Applicants: Jun-Ryeong YOO, Yangju-si, Gyeonggi-do (KR); CARIS GUARD RAIL CO., LTD., Uijeongbu-si, Gyeonggi-do (KR)

(72) Inventor: Jun-Ryeong YOO, Gyeonggi-do (KR)

(73) Assignee: Caris Guard Rail Co., Ltd., Uijeongbu-si, Gyeonggi-do (KR)

(21) Appl. No.: 15/526,222

(22) PCT Filed: Mar. 3, 2017
(86) PCT No.: PCT/KR2017/002292

§ 371 Date: May 11, 2017

(51) Int. Cl. E01F 15/04; B29C 47/06; B29C 47/00

(52) U.S. Cl. CPC E01F 15/0453; B29C 47/065; B29K 2101/12; B29C 47/003; E01F 15/0484; B29C 47/0028

(57) ABSTRACT

This invention relates to a plastic guardrail, extruded into a structure having multiple layers and ribs between the layers using a thermoplastic resin, and configured such that an outer layer using a material having high strength to increase impact resistance, and an inner layer and the ribs using a material having lower strength than that of at least the outer layer to increase an internal cushioning effect are integrated with each other through a double extrusion process. The guardrail of the invention can exhibit both impact resistance and a cushioning function.

### TECHNICAL FIELD

The present invention relates to a guardrail provided alongside a road, and more particularly to a plastic guardrail formed by extruding a plastic.

### BACKGROUND ART

Typically, guardrails are provided along the sides of a road in order to display the boundary of the road and to prevent vehicles from driving off the road. Such guardrails are required to have not only high impact strength to prevent the vehicle from being released when colliding therewith, but also the ability to absorb impacts applied to the vehicle and guardrails. These requirements are to protect drivers and passengers.

Such a guardrail is made of a metal plate pressed in a continuous waveform, and is continuously disposed and fixed to rail posts suitably arranged along the side of a road. However, such metal guardrails suffer from inconvenient handling, high risk and low workability, and are also problematic in terms of corrosion and lack of cushioning capability to absorb impacts. Hence, there has been proposed the use of plastic materials or the addition of cushioning elements.

In this regard, Korean Utility Model No. 180108 discloses a guardrail in which an impact-relieving member formed of a polymer is attached to the surface of a metal plate, thereby relieving impact in the event of a vehicle collision. In this case, however, the production and attachment of such a guardrail incur high costs and take a long time, remarkably deteriorating productivity, which is undesirable.

Also, Korean Utility Model No. 308889 discloses a guardrail formed merely of a synthetic resin or FRP. However, this case is problematic in that there is no particular consideration given to the strength, stiffness or cushioning functions of the materials, despite various proposals including the addition of fastening structures or reflection structures to guardrails having similar materials.

Hence, the formation of air layers inside the guardrail has been devised. Korean Patent Nos. 466411 and 897583 and Korean Patent Application Publication No. 2010-109080 disclose guardrails using a synthetic resin or other resin in which air layers are formed and individual layers are connected by means of linear ribs having a straight shape or a V shape or honeycomb-shaped ribs. This configuration may exhibit a high cushioning effect compared to the aforementioned simple plate-type guardrails. However, the following two problems occur.

First, guardrails typically have to have high impact strength, as described above. However, the disclosed guardrails are focused only on providing a cushioning function, and no methods have been proposed regarding the basic impact strength.

Second, the linear ribs in the connection of individual layers are merely used to connect the layers and do not aid in absorbing or relieving impact. On the other hand, honeycomb-shaped ribs are known to relieve impact but the molding thereof is difficult in practice.

### DISCLOSURE

### Technical Problem

The present invention has been made keeping in mind the problems with guardrails encountered in the related art. The present invention is intended to provide a guardrail, which may take into consideration both impact strength and a cushioning function.

### Technical Solution

The present invention provides a guardrail, extruded into a structure having multiple layers and ribs between the layers using a thermoplastic resin, and configured such that an outer layer, which uses a material having high strength thus having increased impact resistance, and an inner layer and the ribs, which use a material having lower strength than that of at least the outer layer to increase an internal cushioning effect, are integrated with each other through a double extrusion process.

Here, the ribs may be formed in a round shape or an arc shape, and an air layer 17 between the outer layer and the inner layer or in the inner layer may be provided in a continuous oval shape.

Preferably, the outer layer is formed using an engineering resin selected from among PA, PC, POM (polyacetyl), PBT (polybutylene terephthalate), MPPO (modified polyphenylene oxide), and PET, and the inner layer is formed using a general-purpose resin selected from among PE, PP, PVC, PS, ABS, AS (acrylonitrile styrene copolymer), and MBS (methacrylate resin).

### Advantageous Effects

According to the present invention, a guardrail is formed in a multilayer structure using a plastic material, and is configured such that a material having high strength is used for an outer layer and a material having relatively low strength is used for the inside thereof. Thus, the guardrail of the invention can exhibit both impact resistance and a cushioning function. Here, interlaminar air layers are responsible for enhancing the cushioning function of the guardrail.

Also, ribs, which are in a round shape or an arc shape, function to elastically absorb and relieve impact. Accordingly, the guardrail of the invention is effective at ensuring both impact resistance and a cushioning function.

### BRIEF DESCRIPTION OF DRAWINGS

FIG. is a perspective view of a guardrail according to the present invention;

FIG. 2 is an enlarged cross-sectional view showing part “A” of FIG. 1; and

FIG. 3 shows the status of use of FIG. 1

### DESCRIPTION OF REFERENCE NUMERALS IN THE DRAWINGS

| | |
|---|---|
| 10: guardrail | 14: fixing hole |
| 15: fixing bolt | 16: rib |
| 17: air layer | 18: outer layer |
| 19: inner layer | |

### Best Mode

The features and effects of a plastic guardrail according to the present invention, whether mentioned or not, will become more apparent through the description of embodiments with reference to the appended drawings. Throughout the drawings, the reference numeral 10 designates a guardrail according to the present invention. With reference to FIG. 1, the guardrail 10 according to the present invention is a plate that has a continuous waveform in a longitudinal direction and extends long in a width direction, and the end of which is connected to an additional guardrail 10.

For such connection, fastening holes 11 that are formed in ends of two guardrails 10 facing each other, bolts 12 respectively passing through the fastening holes 11, and washer members 13 into which two bolts 12 are fitted on the rear surfaces of the guardrails 10 so that the two guardrails 10 are connected, are provided. Here, the plate shape and connection structure of the guardrails 10 are not particularly limited in the present invention.

Throughout the drawings, the reference numerals 14 and 15 are a fixing hole and a fixing bolt, respectively, which are used to mount the guardrail 10 of the present invention to a rail post on a side of a road.

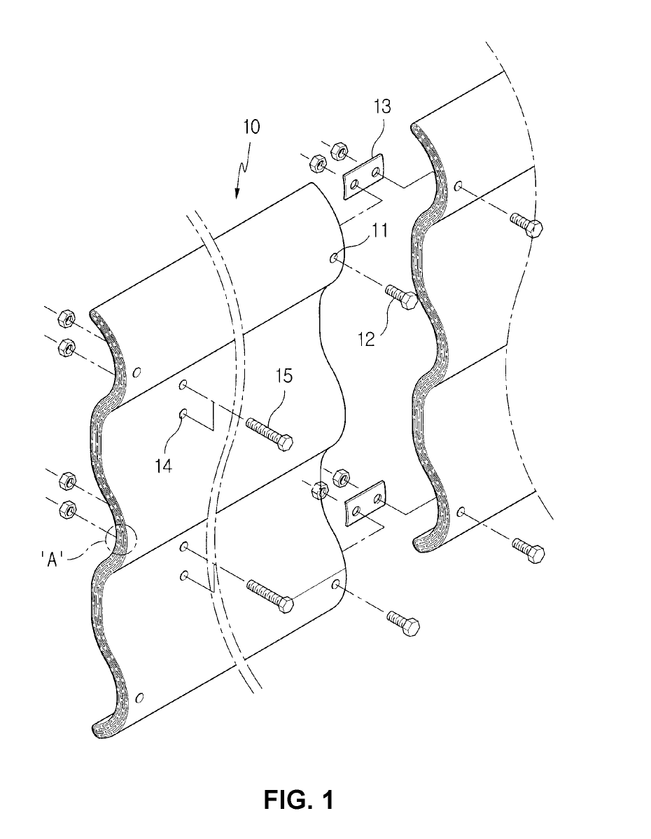

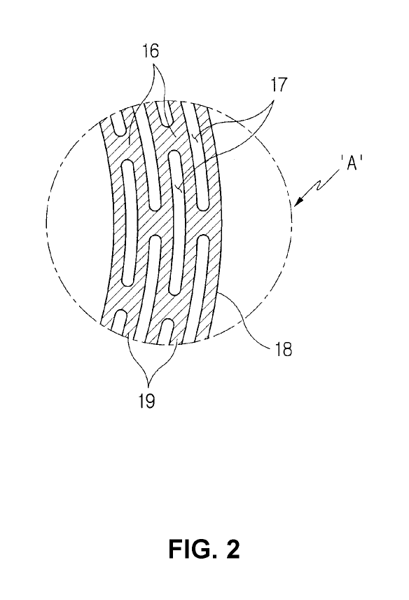

With reference to FIG. 2, the guardrail 10 of the present invention is formed in a multilayer structure, the layers of which are connected through a plurality of ribs 16 formed at interlaminar air layers. Here, the ribs 16 are formed in a round shape or an arc shape, and the interlaminar air layers 17 formed between the outer layer 18 and the inner layer 19 or in the inner layer 19 are provided in the form of a continuous oval shape 17.

In the present invention, the guardrail 10 is extruded into a structure having multiple layers and ribs 16 between the layers using a thermoplastic plastic resin. Here, the outer layer 18, using a material having high strength in order to enhance impact resistance, and the inner layer 19 and the ribs 16, using a material having lower strength than that of at least the outer layer 18 in order to enhance an internal cushioning effect, are integrated with each other using a double extraction process.

Useful as the material of the outer layer 18, an engineering resin known to have strength to the extent that it is used for interior and exterior parts of vehicles may be selected from among PA, PC, POM (polyacetyl), PBT (polybutylene terephthalate), MPPO (modified polyphenylene oxide), and PET. The material of the inner layer 19 may include any general-purpose resin selected from among PE, PP, PVC, PS, ABS, AS (acrylonitrile styrene copolymer), and MBS (methacrylate resin).

Preferably, the material of the outer layer 18 is a PC resin having the highest impact strength among thermoplastic and engineering resins, and the material of the inner layer 19 is a PVC resin, which is the most useful general-purpose resin.

In the present invention, the double extrusion process is a typical extraction process using a molding machine so as to form a plate through double extrusion performed in a manner in which a material extruded from the head of a first extruder is formed into an inner resin product, and a material extruded from the head of a second extruder is formed into an outer resin product, thereby producing a plate-type guardrail 10 having the outer layer 18, the inner layer 19 and the ribs 16 formed using different materials.

In this structure, the impact strength of the guardrail 10 is ensured by the outer layer 18 made of the above material. The cushioning effect of the guardrail 10 is ensured and enhanced by means not only of the ribs 16 and the inner layer 19 using the above material but also of the plate waveform and the air layers 17. As the ribs 16 are formed in a round shape or an arc shape, impacts may be elastically absorbed well in comparison to simple straight-shaped ribs.

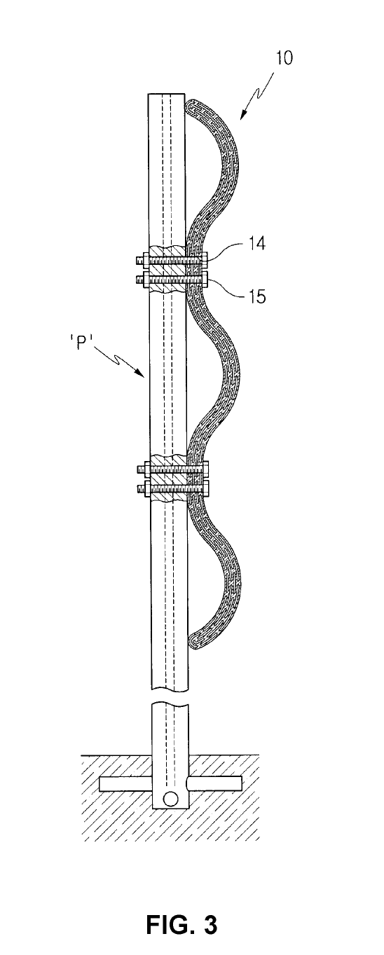

With reference to FIG. 3, the guardrail 10 of the present invention is mounted by bringing the waveform portions thereof into contact with posts P on a side of a road and then fitting fixing bolts 15 into fixing holes 14. As illustrated in FIG. 1, individual guardrails 10 may be connected and extended in a width direction by means of the bolts 12 and washer members 13.

As described hereinbefore, the guardrail 10 of the present invention is formed in a multilayer structure using a plastic material, in which a material having high strength is used for the outer layer 18 and a material having relatively low strength is used for the inside thereof. Therefore, the guardrail 10 of the invention is capable of exhibiting both impact resistance and a cushioning function. Also, the interlaminar air layers 17 are responsible for a cushioning function.

Meanwhile, the ribs 16 in a round shape or an arc shape play a role in elastically absorbing and relieving impacts. Therefore, the guardrail 10 of the invention is effective at ensuring both impact resistance and a cushioning function.

1. A plastic guardrail, extruded into a structure having multiple layers and ribs between the layers using a thermoplastic resin, and configured such that an outer layer, using a material having high strength to increase impact resistance, and an inner layer and the ribs, using a material having lower strength than that of at least the outer layer to increase an internal cushioning effect, are integrated with each other through a double extrusion process,
wherein the ribs are formed in a round shape or an arc shape,
the outer layer is formed using an engineering resin selected from among PA, PC, POM (polyacetyl), PBT (polybutylene terephthalate), MPPO (modified polyphenylene oxide), and PET, and
the inner layer is formed using a general-purpose resin selected from among PE, PP, PVC, PS, ABS, AS (acrylonitrile styrene copolymer), and MBS (methacrylate resin).

2. The plastic guardrail of claim 1, wherein an air layer between the outer layer and the inner layer or in the inner layer is provided in a continuous oval shape.
